(19) United States
(12) Patent Application Publication
(10) Pub. No.: US 2016/0370026 A1
(43) Pub. Date: Dec. 22, 2016

(54) POST-INSTALLATION LEARNING FAULT DETECTION

(71) Applicant: Trane International Inc., Davidson, NC (US)

(72) Inventors: Darryl E. Denton, Tyler, TX (US); Jeffrey L. Stewart, Whitehouse, TX (US); Carl L. Garrett, Tyler, TX (US)

(73) Assignee: Trane International Inc., Davidson, NC (US)

(21) Appl. No.: 15/189,378

(22) Filed: Jun. 22, 2016

Related U.S. Application Data
(60) Provisional application No. 62/182,802, filed on Jun. 22, 2015.

(51) Int. Cl. F24F 11/00; G05B 17/02; G06F 11/30

(52) U.S. Cl. CPC F24F 11/0086; G06F 11/30; G05B 17/02; F24F 2011/0052; F24F 2011/0075; F24F 2011/0068

(57) ABSTRACT

A fault detection module and related methods of prognostic fault detection for an HVAC system are disclosed. Baseline operating parameters of an HVAC system operating in a known balanced state are collected during a calibration period. A set of coefficients for an enthalpy model are generated from the collected baseline parameters to define the balanced operation of the HVAC system. During normal operating times, runtime operating parameters of the HVAC system are collected. The expected high-side and low-side enthalpies are computed using the enthalpy model, and compared to actual high-side and low-side enthalpies. The relationships between expected and actual enthalpies are utilized to determine whether a potential or actual fault condition exists, and optionally, the nature of the fault. A fault message indicating the fault is transmitted to one or more recipient devices.

### CROSS-REFERENCE TO RELATED APPLICATION

This application claims the benefit of and priority to U.S. Provisional Application Ser. No. 62/182,802 entitled “POST-INSTALLATION LEARNING FAULT DETECTION” and filed Jun. 22, 2015, the entirety of which is hereby incorporated by reference herein for all purposes.

### BACKGROUND

1. Technical Field

The present disclosure is directed to improving the reliability of HVAC components, and in particular, to improved systems, apparatus, and methods for monitoring performance of an HVAC system to identify potential or imminent failures before they occur.

2. Background of Related Art

Heating, ventilation, and air conditioning (HVAC) systems represent a sizable investment to a homeowner or owner of commercial property, who rely upon HVAC system to provide building occupants with year-round comfort. Proper HVAC performance depends on many elements operating together which include proper system specification and sizing, proper installation of all system components, and proper operation of each component from which the system is built. For example, a typical HVAC system installation includes an outdoor unit (either an air conditioner condensing unit or a heat pump), an indoor unit (furnace/coil combination, a modular air handler, a dedicated air handler, and the like), a package unit (combination outdoor and indoor unit in a common enclosure), a controller (e.g., a thermostat), tubing to circulate refrigerant between the outdoor and indoor unit, and electrical wiring to provide control signals and power to the various HVAC components.

Any performance degradation in a single HVAC system component has the potential to impact the operation of the entire system. At a minimum, a degraded or malfunctioning component may impair system efficiency, while at worst, may cause a ripple effect failure in other components and/or total system failure. In some instances, a failure in a newly-installed system may be related to an installation defect, such as a leaky refrigerant line. In other instances, a component may fail shortly after being placed into service. While any failure is undesirable, a failure in a newly-installed system is particularly unwelcome as it may lead to an unsatisfactory customer experience. An HVAC system that detects and avoids potential failures in newly-installed equipment would improve the customer experience, increase the overall reliability of the system, and be a welcome advance in the art

### SUMMARY

In one aspect, the present disclosure is directed to a method of fault detection in an HVAC system. In an embodiment, the method includes receiving baseline operating parameters of an HVAC system operating in a known balanced state, computing a set of coefficients from the baseline operating parameters for an enthalpy model defining a balanced HVAC system, receiving runtime operating parameters of the HVAC system while the HVAC system is operating in an unknown state, computing an expected enthalpy using the enthalpy model, computing an actual enthalpy using the runtime operating parameters, and transmitting a fault message if the actual enthalpy differs from the expected enthalpy by more than a predetermined amount.

In some embodiments, the enthalpy model may optionally or alternatively include an evaporator enthalpy model, a condenser enthalpy model, and/or a compressor enthalpy model. In some embodiments, the evaporator enthalpy model is defined by the formula Hₑ=Mₑ×(TWₑ−TSₑ)+ML×TL+Bₑ. In some embodiments, the condenser enthalpy model is defined by the formula H_{c}=M_{c}×(TS_{c}−TA_{c})+ML_{c}×TL+M_{ew}×TWₑ+B_{c}. In some embodiments, the compressor enthalpy model is defined by the formula H_TS_{c}=H_TSₑ₂₀+(a+b*T_{css}+c*T_{csd} d*T_{css}² e*T_{css}*T_{csd} f*T_{csd}² g*T_{css}³ h*T_{csd}*T_{css}²+i*T_{css}*T_{csd}² j*T_{csd}³)/M_{c}×3.412.

In some embodiments of the method, the operating parameters of the HVAC may include compressor input power, compressor mass flow, suction saturated temperature, discharge saturated temperature, indoor liquid temperature, indoor dry bulb temperature, indoor wet bulb temperature, outdoor dry bulb temperature, and outdoor wet bulb temperature.

In some embodiments, receiving baseline operating parameters includes recording the range of outdoor dry bulb temperatures seen during a first sampling period. In some embodiments, the method includes receiving, during a second sampling period, supplemental operating parameters over a range of outdoor dry bulb temperatures different from those seen during the first sampling period. In some embodiments, the method includes computing, from the baseline operating parameters and the supplemental operating parameters, a set of revised coefficients for the enthalpy model defining a balanced HVAC system. In some embodiments, computing an expected enthalpy includes computing an expected high side enthalpy and an expected low side enthalpy, and wherein computing an actual enthalpy includes computing an actual high side enthalpy and an actual low side enthalpy. In some embodiments, the method includes determining a high side delta indicative of the difference between the expected high side enthalpy and the actual high side enthalpy, determining a low side delta indicative of the difference between the expected low side enthalpy and the actual low side enthalpy, comparing the high side delta and the low side delta to a set of known fault conditions to determine whether a match exists, and formatting the fault message to identify the matched fault in response to a determination that a match exists.

In another aspect, the present disclosure is directed to a post-installation fault detection unit for an HVAC system. In an embodiment, the post-installation fault detection unit includes a processor operatively coupled to non-transitory memory. The non-transitory memory includes a set of executable instructions which, when executed on the processor, cause the processor to compute a set of coefficients for an enthalpy model from a plurality of sensor signals provided by the HVAC system when the HVAC system is operating in a known balanced state, determine an expected enthalpy from the enthalpy model, determine an actual enthalpy from a plurality of sensor signals provided by the HVAC system when the HVAC system is operating in an unknown state, compare the expected enthalpy to the actual enthalpy, and transmit a fault message if the actual enthalpy differs from the expected enthalpy by more than a predetermined amount. The post-installation fault detection unit includes a diagnostic interface in operative communication with the processor and configured for receiving a plurality of sensor signals, and a communication interface in operative communication with the processor and configured for transmitting the fault message.

In some embodiments, the plurality of sensor signals includes sensor signals may include compressor input power or current, compressor efficiency, compressor mass flow, suction saturated temperature, discharge saturated temperature, indoor liquid temperature, indoor dry bulb temperature, indoor wet bulb temperature, outdoor dry bulb temperature, and outdoor wet bulb temperature. In some embodiments, the diagnostic interface is configured for receiving a compressor input power sensor signal from a variable speed drive operatively associated with the compressor. In some embodiments, the communication interface is further configured for operative communication with a destination selected from the group consisting of a thermostat, a user device, and a remote database. In some embodiments, the diagnostic interface is further configured to transmit a fault message to a diagnostic display unit.

In yet another aspect, the present disclosure is directed to an HVAC outdoor unit. In an embodiment, the disclosed HVAC outdoor unit includes a compressor having an inlet and an outlet. A variable-speed drive unit is configured to drive an electric motor at variable speed, and the electric motor is operatively associated with the compressor. The variable-speed drive unit is configured to generate an input power signal indicative of the input power of the electric motor. The HVAC outdoor unit includes a suction sensor configured to generate a suction signal indicative of a suction pressure at the compressor inlet, a discharge sensor configured to generate a discharge signal indicative of a discharge pressure at the compressor outlet, a dry bulb temperature sensor configured to generate an outdoor dry bulb temperature signal, and a wet bulb temperature sensor configured to generate an outdoor wet bulb temperature signal. The HVAC outdoor unit includes a fault detection unit configured to receive a plurality of sensor signals including at least the input power signal, the suction signal, the discharge signal, the outdoor dry bulb temperature signal, and the outdoor wet bulb temperature signal. The fault detection unit is configured to compute a set of coefficients for an enthalpy model from the plurality of sensor when the HVAC outdoor unit is operating in a known balanced state, determine an expected enthalpy from the enthalpy model, determine an actual enthalpy from the plurality of sensor signals when the HVAC outdoor unit is operating in an unknown state, compare the expected enthalpy to the actual enthalpy, and transmit a fault message if the actual enthalpy differs from the expected enthalpy by more than a predetermined amount. In an embodiment, the fault detection unit is further configured to receive, from an HVAC indoor unit, sensor signals including at least a liquid temperature signal, an indoor dry bulb temperature signal, and an indoor wet bulb temperature signal.

In still another aspect, the present disclosure is directed to an HVAC indoor unit. In an embodiment, the disclosed HVAC indoor unit includes an evaporator coil having an inlet, a liquid temperature sensor configured to generate a liquid temperature signal indicative of the refrigerant temperature at the evaporator inlet, a dry bulb temperature sensor configured to generate an indoor dry bulb temperature signal, a wet bulb temperature sensor configured to generate an indoor wet bulb temperature signal, and a fault detection unit. The fault detection unit is configured to receive a plurality of sensor signals including at least the liquid temperature signal, the indoor dry bulb temperature signal, and the indoor wet bulb temperature signal. The fault detection unit is configured to compute a set of coefficients for an enthalpy model from the plurality of sensor when the HVAC indoor unit is operating in a known balanced state, determine an expected enthalpy from the enthalpy model, determine an actual enthalpy from the plurality of sensor signals when the HVAC indoor unit is operating in an unknown state, compare the expected enthalpy to the actual enthalpy, and transmit a fault message if the actual enthalpy differs from the expected enthalpy by more than a predetermined amount. In an embodiment, the fault detection unit is further configured to receive, from an HVAC outdoor unit, sensor signals including at least an input power signal, a suction signal, a discharge signal, an outdoor dry bulb temperature signal, and an outdoor wet bulb temperature signal.

In a further aspect, the present disclosure is directed to an HVAC system. In an embodiment, the HVAC system includes an HVAC outdoor unit and an HVAC indoor unit. The HVAC outdoor unit includes a compressor having an inlet and an outlet and a variable-speed drive unit configured to drive an electric motor operatively associated with the compressor at variable speed. The variable-speed drive unit is configured to generate an input power signal indicative of the input power of the electric motor. The HVAC outdoor unit includes a suction sensor configured to generate a suction signal indicative of a suction pressure at the compressor inlet, a discharge sensor configured to generate a discharge signal indicative of a discharge pressure at the compressor outlet, a dry bulb temperature sensor configured to generate an outdoor dry bulb temperature signal, and a wet bulb temperature sensor configured to generate an outdoor wet bulb temperature signal. The HVAC indoor unit includes an evaporator coil having an inlet, a liquid temperature sensor configured to generate a liquid temperature signal indicative of the refrigerant temperature at the evaporator inlet, a dry bulb temperature sensor configured to generate an indoor dry bulb temperature signal, and a wet bulb temperature sensor configured to generate an indoor wet bulb temperature signal. The HVAC system includes a fault detection unit configured to receive a plurality of sensor signals including at least the input power signal, the suction signal, the discharge signal, the outdoor dry bulb temperature signal, the outdoor wet bulb temperature signal, the liquid temperature signal, the indoor dry bulb temperature signal, and the indoor wet bulb temperature signal. The fault detection unit is configured to compute a set of coefficients for an enthalpy model from the plurality of sensor when the HVAC outdoor unit is operating in a known balanced state, determine an expected enthalpy from the enthalpy model, determine an actual enthalpy from the plurality of sensor signals when the HVAC outdoor unit is operating in an unknown state, compare the expected enthalpy to the actual enthalpy, and transmit a fault message if the actual enthalpy differs from the expected enthalpy by more than a predetermined amount.

### BRIEF DESCRIPTION OF THE DRAWINGS

Various embodiments of the disclosed system and method are described herein with reference to the drawings wherein:

FIG. 1 is a schematic diagram of an HVAC system incorporating a post-installation fault detection system in accordance with an embodiment of the present disclosure;

FIG. 2 illustrates a method of performing post-installation fault detection in an HVAC system in accordance with an embodiment of the present disclosure;

FIGS. 3A-3F depict pressure-enthalpy relationships in an HVAC system in accordance with the present disclosure;

FIG. 4A depicts an exemplary table of parameter snapshots showing measured and computed HVAC parameters in accordance with an embodiment of the present disclosure;

FIG. 4B depicts an exemplary set of derived coefficients and corresponding values obtained during curve-fitting in accordance with an embodiment of the present disclosure;

FIG. 4C depicts a relationship between a curve-fit solution and measured enthalpies in accordance with an embodiment of the present disclosure; and

FIGS. 5A-5D depicts relationships between target and measured enthalpies under fault conditions in accordance with embodiments of the present disclosure.

The various aspects of the present disclosure mentioned above are described in further detail with reference to the aforementioned figures and the following detailed description of exemplary embodiments.

### DETAILED DESCRIPTION

Particular illustrative embodiments of the present disclosure are described hereinbelow with reference to the accompanying drawings; however, the disclosed embodiments are merely examples of the disclosure, which may be embodied in various forms. Well-known functions or constructions and repetitive matter are not described in detail to avoid obscuring the present disclosure in unnecessary or redundant detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In this description, as well as in the drawings, like-referenced numbers represent elements which may perform the same, similar, or equivalent functions. The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The present disclosure is described herein in terms of functional block components and various processing steps. It should be appreciated that such functional blocks configured to perform the specified functions may be embodied in analog circuitry, digital circuitry, and/or instructions executable on a processor. For example, the present disclosure may employ various discrete components, integrated circuit components (e.g., memory elements, processing elements, logic elements, look-up tables, and the like) which may carry out a variety of functions, whether independently, in cooperation with one or more other components, and/or under the control of one or more processors or other control devices. It should be appreciated that the particular implementations described herein are illustrative of the disclosure and its best mode and are not intended to otherwise limit the scope of the present disclosure in any way.

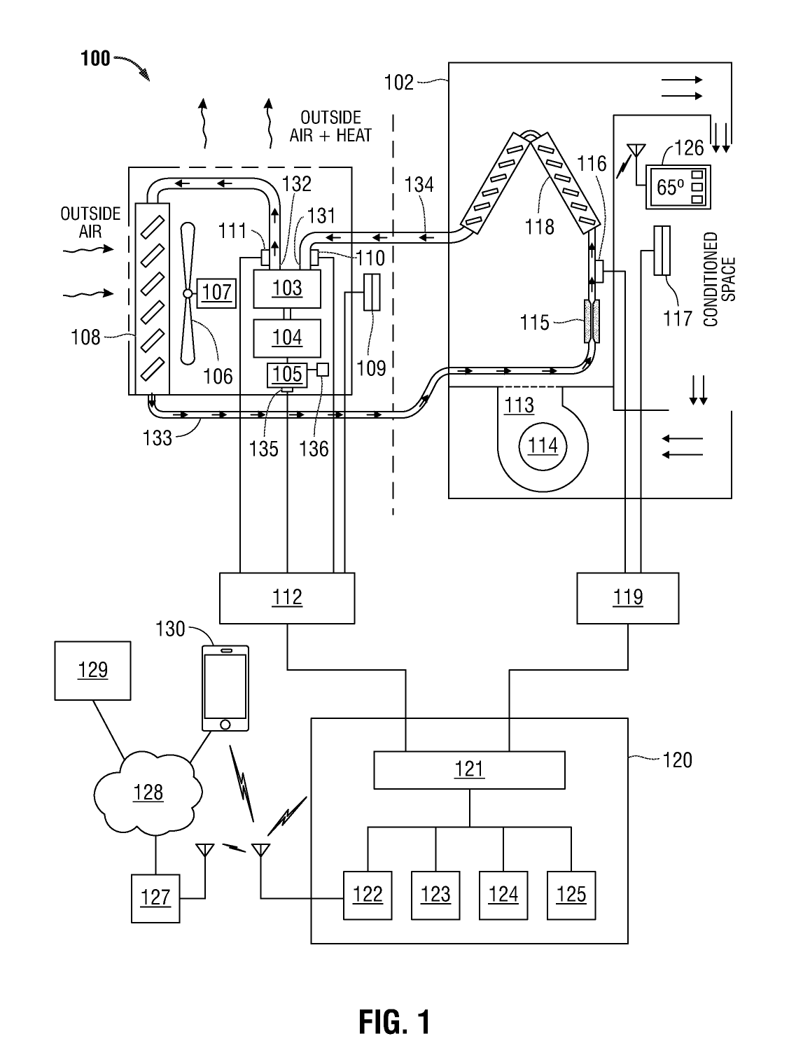

Referring to FIG. 1, an exemplary embodiment of an HVAC system 100 having a post-installation fault detection unit (FDU) 120 in accordance with the present disclosure is shown. FDU 120 is operatively associated with HVAC system 100 that includes an outdoor unit 101 and an indoor unit 102. Outdoor unit 101 includes an electric motor 104 operatively engaged in rotational communication with compressor 103, and an electric motor 107 configured to drive a fan 106. Outdoor unit 101 includes a variable frequency inverter drive unit (VSD) 105 configured to drive electric motor 104, and thus compressor 103, at variable speed. Outdoor unit 102 optionally includes a second VSD unit (not explicitly shown) that drives motor 107 and fan 106 at variable speed to circulate outdoor air through outdoor heat exchanger 108 (e.g., a condenser coil). Indoor unit 101 includes an electric motor 114 that drives a centrifugal blower 113 to circulate indoor air through indoor heat exchanger 118 (e.g., an evaporator coil).

In use, outdoor unit 101 and indoor unit 102 interoperate to perform a vapor compression refrigeration cycle. Circulating refrigerant, such as R-410A, enters compressor 103 through inlet 131 as superheated vapor. Compressor 103, driven by motor 104, increases the pressure and temperature of the refrigerant, resulting in superheated vapor which exits compressor 103 via outlet 132. Superheated vapor flows through outdoor heat exchanger 108, where the superheated refrigerant vapor is cooled and condensed into saturated liquid form, moving heat from the refrigerant into outside air driven through an outdoor heat exchanger 108 by fan 106. The refrigerant then flows via high pressure conduit 133 from outdoor unit 101 to an expansion valve 115, which may include a thermostatic expansion valve (TXV), electronic expansion valve (EXV) or orifice control. Expansion valve 115 causes the high-pressure refrigerant to undergo an abrupt reduction in pressure, causing adiabatic flash evaporation of a portion of the liquid refrigerant, which, in turn, lowers the temperature of the liquid and vapor refrigerant mixture. The cold liquid and vapor mixture flows through an indoor heat exchanger 118 (e.g., evaporator) included within indoor unit 102. Blower 113 draws in warm indoor air from the conditioned space (e.g., the interior of the building) and drives it through indoor heat exchanger 118. Heat from the indoor air is transferred into the refrigerant, causing it to expand and vaporize within indoor heat exchanger 118, cooling the indoor air, which returns to the conditioned space. Warm refrigerant vapor exiting indoor heat exchanger 118 returns to outdoor unit 101 via low pressure conduit 134, and the vapor compression refrigeration cycle continues. A thermostat 126 or other suitable setpoint controller is in operable communication with outdoor unit 101 and indoor unit 102. Thermostat is situated within the conditioned space, and is configured to activate and deactivate outdoor unit 101 and indoor unit 102 as required to maintain the conditioned space at a desired setpoint temperature.

It should be understood that, while the present example embodiment illustrates HVAC system 100 configured as an air conditioning system, HVAC system 100 may be configured as a heat pump system. Further, it should be understood that, while the present example embodiment illustrates a variable speed compressor drive arrangement, embodiments of the present disclosure are suitable for use with a single speed compressor drive, an offloading compressor, dual compressor arrangement, and other compressor arrangements.

FDU 120 monitors operational parameters of HVAC system 100 via sensors associated with outdoor unit 101 and indoor unit 102 to establish a baseline enthalpy target indicative of proper operation of the system, and to compare subsequent operational parameters with the target to determine whether a fault or pre-fault condition has developed. Outdoor unit 101 includes a suction sensor 110 and a discharge sensor 111 that are operatively associated with compressor inlet 131 and outlet 132, respectively. Suction sensor 110 may be configured to sense suction temperature, e.g., the suction saturation temperature, and/or may be configured to sense suction pressure, which is a proxy for suction temperature as described below. In the example embodiment shown in FIG. 1, suction sensor 110 is configured to sense refrigerant pressure at inlet 131 of compressor 103 and generate a corresponding suction sensor signal indicative thereof. In some embodiments, suction sensor 110 is configured to sense refrigerant conditions at compressor inlet 131 and generate a corresponding suction sensor signal indicative of refrigerant saturation temperature.

Discharge sensor 111 may be configured to sense pressure and/or temperature. In the example embodiment shown in FIG. 1, discharge sensor 111 is configured to sense refrigerant pressure at outlet 132 of compressor 103 and to generate a corresponding discharge sensor signal indicative thereof. In some embodiments, discharge sensor 111 may be configured to sense refrigerant conditions, e.g., discharge saturation temperature, at compressor outlet 132, and to generate a corresponding discharge sensor signal indicative of refrigerant temperature. Note that, since refrigerant pressure at inlet 131 and/or outlet 132 is related to refrigerant temperature, sensed pressure values are readily converted to temperature and/or may be used in place of temperature, and vice versa, by employing a conversion coefficient, table, or formula known in the art. Outdoor unit 101 includes an outdoor thermometer assembly 109 that is configured to sense the outdoor ambient wet bulb temperature (e.g., the temperature of adiabatic saturation of the outdoor environment) and the outdoor air temperature (dry bulb temperature) and to provide corresponding outdoor wet bulb and outdoor dry bulb temperature signals, respectively. Compressor VSD 105 includes a data interface 135 that is configured to provide operational parameters associated with motor 104 and/or compressor 103. In the exemplary embodiment of FIG. 1, data interface 135 provides signals indicative of motor input power and motor speed (e.g., compressor speed). VSD 105 includes a diagnostic display unit (DDU) 136 which is configured to store and/or display diagnostic information (e.g., fault codes) received from FDU 120.

Indoor unit 102 includes a liquid temperature sensor 116 that is configured to sense the temperature of cold refrigerant entering evaporator 118 and to provide a sensor signal corresponding thereto. Indoor unit 102 includes an indoor thermometer assembly 117 that is configured to sense the indoor ambient wet bulb temperature and the indoor dry bulb temperature, and to provide corresponding indoor wet bulb and indoor dry bulb temperature signals, respectively.

In some embodiments, outdoor wet bulb temperature and/or outdoor wet bulb temperature may be alternatively be determined by calculating the wet bulb temperature(s) from a dew point measurement and/or a relative humidity measurement. In some embodiments, outdoor wet and dry bulb temperatures may be obtained from a remote sensor and/or remote weather data provider via network 128.

HVAC system 100 includes outdoor data collection unit (ODCU) 112 that is operationally associated with outdoor unit 101, and indoor data collection unit (IDCU) 119 that is operationally associated with indoor unit 102. In some embodiments, ODCU 112 may be incorporated with outdoor unit 101, while in other embodiments, ODCU 112 may be a stand-alone unit, incorporated with FDU 120, and/or with diagnostic interface 121. Likewise, IDCU 119 may be incorporated with indoor unit 102, while in other embodiments, IDCU 119 may be a stand-alone unit, incorporated within FDU 120, and/or within diagnostic interface 121. ODCU 112 is in operative communication with suction sensor 110, discharge sensor 111, VSD 105, and outdoor thermometer assembly 109 to receive the aforedescribed sensor signals provided by each, and, optionally, to provide operating power for active elements which may be included in suction sensor 110, discharge sensor 111, VSD 105, and outdoor thermometer assembly 109. ODCU 112 may additionally or alternatively provide scaling and/or calibration of the one or more of the sensor signals. In embodiments, ODCU 112 encodes the individual sensor signals into an aggregated form suitable for transmission to FDU 120 using digital signaling techniques. In embodiments, ODCU 112 encodes the individual sensor signals into digital data signals compliant with the CANbus protocol initially introduced by Robert Bosch GmbH for transmission to FDU 120. In embodiments, ODCU 112 is configured for communicating with FDU 120 via a wired or wireless data communication link, such as, without limitation, Ethernet, RS-485, 802.11 variants (“WiFi”), 802.15.4 personal area networks (Z-Wave®, ZigBee®), and so forth.

Likewise, IDCU 119 is in operative communication with liquid temperature sensor 116 and indoor thermometer assembly 117 to receive their respective sensor signals, and, optionally, to provide operating power for active elements which may be included in liquid temperature sensor 116 and indoor thermometer assembly 117. Additionally or alternatively, IDCU 119 may provide scaling or calibration of either or both the sensor signals provided by liquid temperature sensor 116 and/or indoor thermometer assembly 117. IDCU 119 may encode the individual sensor signals into an aggregated form suitable for transmission to FDU 120 using digital signaling techniques, as described above with respect to ODCU 112.

Advantageously, in embodiments where ODCU 112 is incorporated with outdoor unit 101 and/or where IDCU 119 is incorporated with indoor unit 102, aggregating the several sensor signals permits the use of interconnects having fewer conductors, thereby reducing wiring costs while increasing reliability though error-correction techniques associated with digital data transmission. In some embodiments, HVAC control signals may be transmitted via the same interconnect as are fault detection sensor signals, further reducing costs and simplifying installation.

In the exemplary embodiment illustrated in FIG. 1, fault detection unit (FDU) 120 comprises an electronic machine having, in operative communication, processor 123, read-write memory 124, non-transitory memory 125, and communication interface 122. Non-transitory memory 125 includes a set of executable instructions, which, when executed on processor 123, causes FDU 120 to perform a method of early fault detection of HVAC system 100 as described in detail below. Diagnostic interface 121 is in operable communication with suction sensor 110, discharge sensor 111, VSD 105, and outdoor thermometer assembly 109 via ODCU 112, and in operable communication with liquid temperature sensor 116 and indoor thermometer assembly 117 via IDCU 119, and is configured for receiving corresponding sensor signals thereof and to convey said signals to processor 123. Read-write memory 124 is configured to provide working storage and may include volatile and/or non-volatile memory. In embodiments, memory 124 may include one or more data structures in which sensor data received by FDU 120, computational results, and/or configuration data are stored.

Communication interface 122 is configured to enable FDU 120 to communicate fault alerts to a remote database 129, a user device 130, and/or thermostat 126. In the illustrated embodiment, communication interface 122 includes the capability for wireless communications via 802.11 variants (“WiFi”) and/or 802.15.4 personal area networks (Z-Wave®, ZigBee®). In some embodiments, FDU 120 communicates with user device 130 and/or thermostat 126 via a local area network, for example, a local WiFi, Z-Wave®, or ZigBee® network. In some embodiments, FDU 120 communicates with remote database 129, user device 130 and/or thermostat 126 via one or more network devices 127 (e.g., a WiFi, Z-Wave®, or ZigBee® router) coupled to a wide area network 128 such as the public Internet.

Aspects of each of diagnostic interface 121 and communication interface 122 may be included in the other. This may prove advantageous where, for example, communications between FDU 120 and ODCU 112, FDU 120 and IDCU 110, and FDU 120 and router 127 utilize the same wireless protocol.

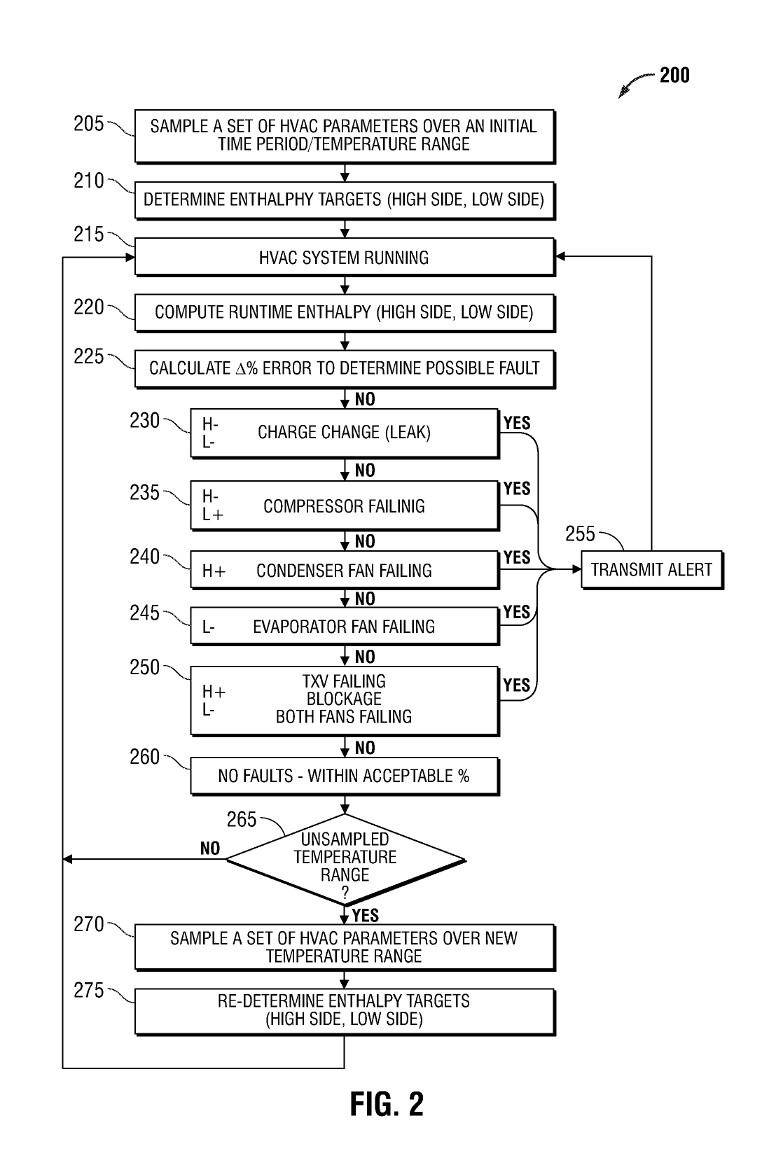

FIG. 2 is a flow diagram illustrating a method of fault detection 200 in an HVAC system in accordance with an embodiment of the present disclosure. In step 205, a set of HVAC parameters is sampled over an initial time period, or “learning” period. The initial learning period commences after the HVAC system is initially installed and certified to be properly operational, and in the present example embodiment continues for five days. In other embodiments, the initial learning period may be less than, or greater than, five days. The high and low outdoor ambient (dry bulb) temperatures seen during the initial learning period are recorded. This initial temperature range is compared to temperatures seen during subsequent learning periods (described below) to augment the initial model with performance data gathered under a variety of temperature conditions. Throughout the learning period, a series of parameter snapshots are collected, optionally at regular intervals, and stored in memory. Each parameter snapshot includes, but is not limited to, data received from the sensors described above: saturated suction temperature, saturated discharge temperature, motor input power, outdoor wet bulb temperature, outdoor dry bulb temperature, evaporator liquid temperature, indoor wet bulb temperature, and/or indoor dry bulb temperature. The snapshot may additionally or optionally include one or both of a timestamp indicative of the time at which the snapshot was collected, and compressor speed.

At the conclusion of the initial learning period, in step 210, a set of models are applied to the collected snapshots to generate a set of best-fit proportionality constants representative of a balanced (e.g., running with no faults) operating state of the HVAC system. For an air conditioning system (cooling-only) or heat pump system in cooling mode, best-fit coefficients Mₑ, Mₗₑ, and Bₑ are determined. For a heat pump system in heating mode, best-fit coefficients Mₑ, Mₗₑ, M_{ew}, and Bₑ are determined. Any suitable type of curve fitting may be employed, including without limitation, a least squares algorithm, a learning or optimization algorithm such as back propagation, first order equations, second order equations, exponential, logarithmic or sigmoid terms, and so forth.

An evaporator model, a condenser model, and a compressor model are used to derive best-fit proportionality coefficients for the collected snapshot data. The evaporator model is defined by equation (1) as set forth below:

Hₑ=Mₑ×(TWₑ−TSₑ)+ML×TL+Bₑ (1)

where He is the refrigerant enthalpy across the evaporator, Me is a proportionality constant, TWe is the evaporator wet bulb temperature (indoor wet bulb temperature), TSe is the evaporator saturation temperature, MLₑ is a proportionality constant, TL is the indoor liquid temperature, and Bₑ is a proportionality constant.

The condenser model is defined by equation (2) as set forth below:

H_{c}=M_{c}×(TS_{c}−TA_{c})+ML_{c}×TL+M_{ew}×TWₑ+Bₑ (2)

where Hₑ is the refrigerant enthalpy across the condenser, Mc is a proportionality constant, TS_{c} is the condenser saturation temperature, TA_{c} is the ambient temperature exposed to the condenser (outdoor dry bulb temperature), ML_{c} is a proportionality constant, TL is the indoor liquid temperature, M_{ew} is a proportionality constant, TWₑ is the evaporator wet bulb temperature, and Bc is a proportionality constant.

A compressor power model is defined by equation (3) as defined in AHRI 540 §6.4, as presented below:

P_{compressor}=a b*T_{css}C*T_{csd}d*T_{css}²e*T_{css}*_{csd}f*T_{csd}²+g*T_{css}³+h*T_{csd}*T_{css}²+i*T_{css}*T_{csd}²+j*T_{csd}³ (3)

where P_{compressor} may represent compressor performance, such as compressor power P_{c}, compressor mass flow M_{c}, compressor current A, and/or compressor unit efficiency E. T_{c}, represents compressor saturated suction temperature and T_{csd} represents compressor saturated discharge temperature. The entering enthalpy H_TSₑ₂₀ (e.g., enthalpy of refrigerant entering the compressor) is determined at 20° superheat. The exiting enthalpy H_TS_{c} (e.g., enthalpy of refrigerant leaving the compressor) is computed as H_TSₑ₂₀+P_{compressor}/M_{c}×3.412. Thus the compressor enthalpy model may be defined as:

H_TS_{c}=H_TSₑ₂₀+(a+b*T_{css}+C*T_{csd}+d*T_{css}²+e*T_{css}*T_{csd}f*T_{csd}²+g*T_{css}³h*T_{csd}*T_{css}²+i*T_{css}*T_{csd}²+j*T_{csd}³)/M_{c}×3.412 (4)

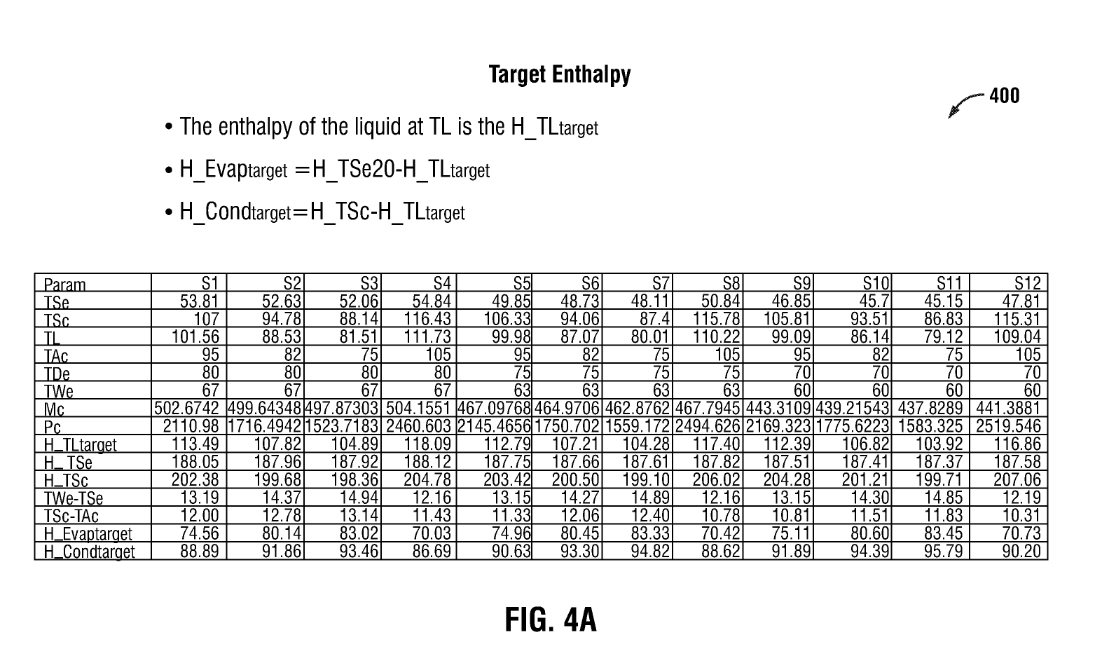

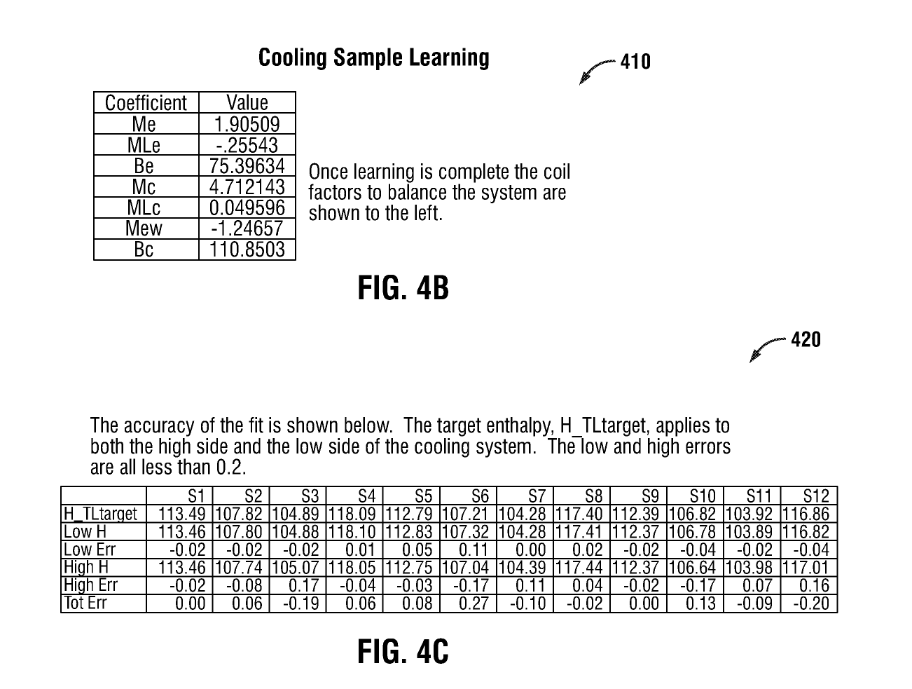

The models are utilized to determine an evaporator enthalpy target H_Evap_{target} and a condenser enthalpy target H_Cond_{target}. FIG. 4A presents a table 400 of an exemplary series of snapshots S₁, S₂, S₃ . . . S₁₂ showing measured and computed HVAC parameters obtained by the inventors. The snapshots were taken during baseline (normal) HVAC operation, from which the actual evaporator (“low side”) enthalpy Hₑ and condenser (“high side”) enthalpy H_{c} are computed. Hₑ and H_{c} are compared to enthalpy targets H_Evap_{target} and H_Cond_{target} to determine whether a fault exists, and if so, the nature of the fault. The target indoor liquid enthalpy H_TL_{target} is determined from TL. The enthalpy targets are determined as follows:

H_Evap_{target}=H_TSₑ₂₀−H_TL_{target} (5)

H_Cond_{target}=H_TS_{c}−H_TL_{target} (6)

FIG. 4B presents an exemplary set of derived coefficients and corresponding values 410 obtained during curve-fitting the dataset of FIG. 4A to the enthalpy models, and FIG. 4C presents a relationship 420 between the curve-fit solution and actual measured enthalpies over the range of snapshots showing good correlation between the model and actual enthalpies for the balanced system.

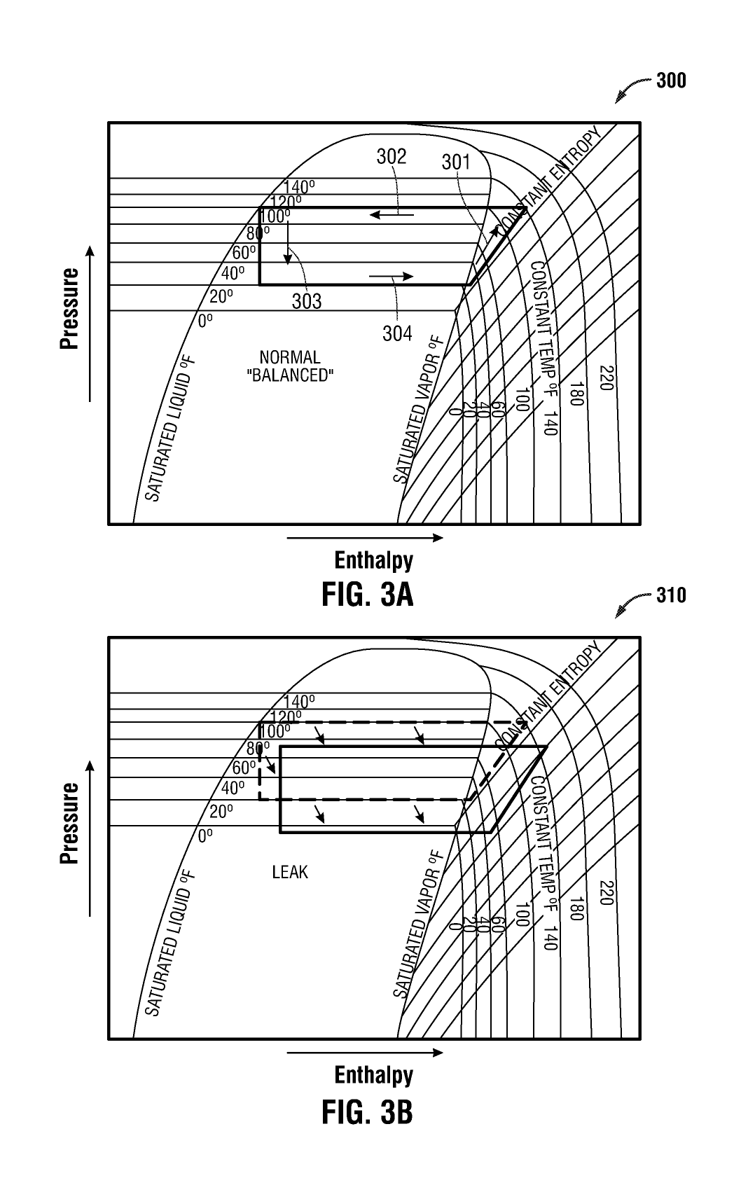

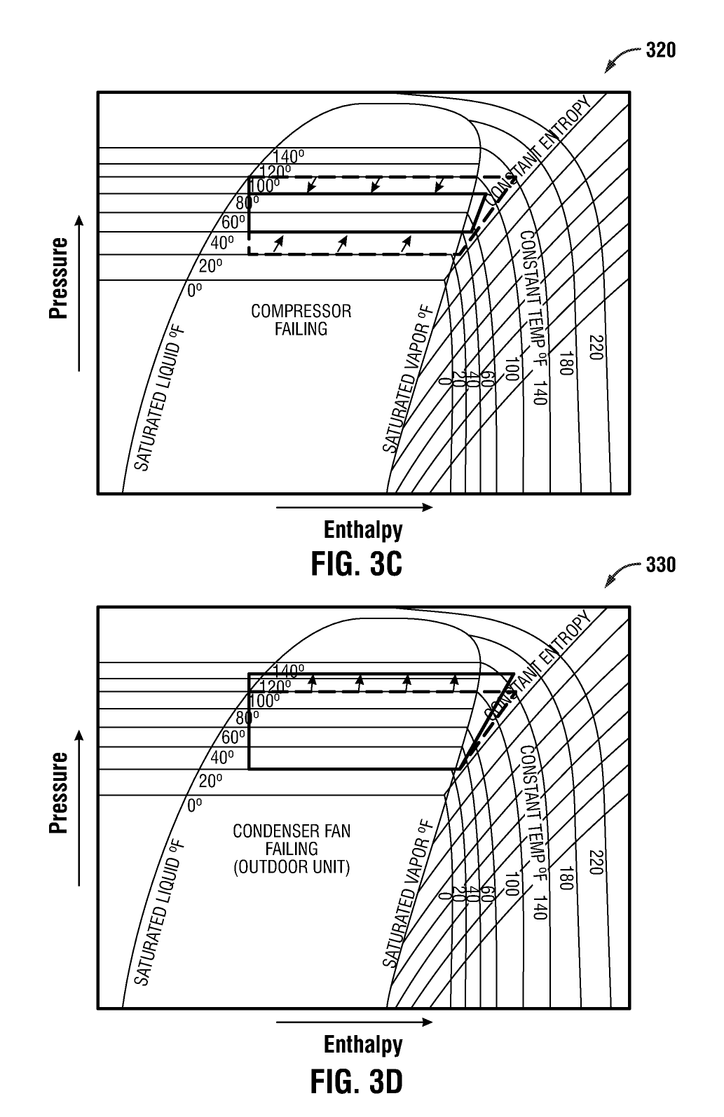

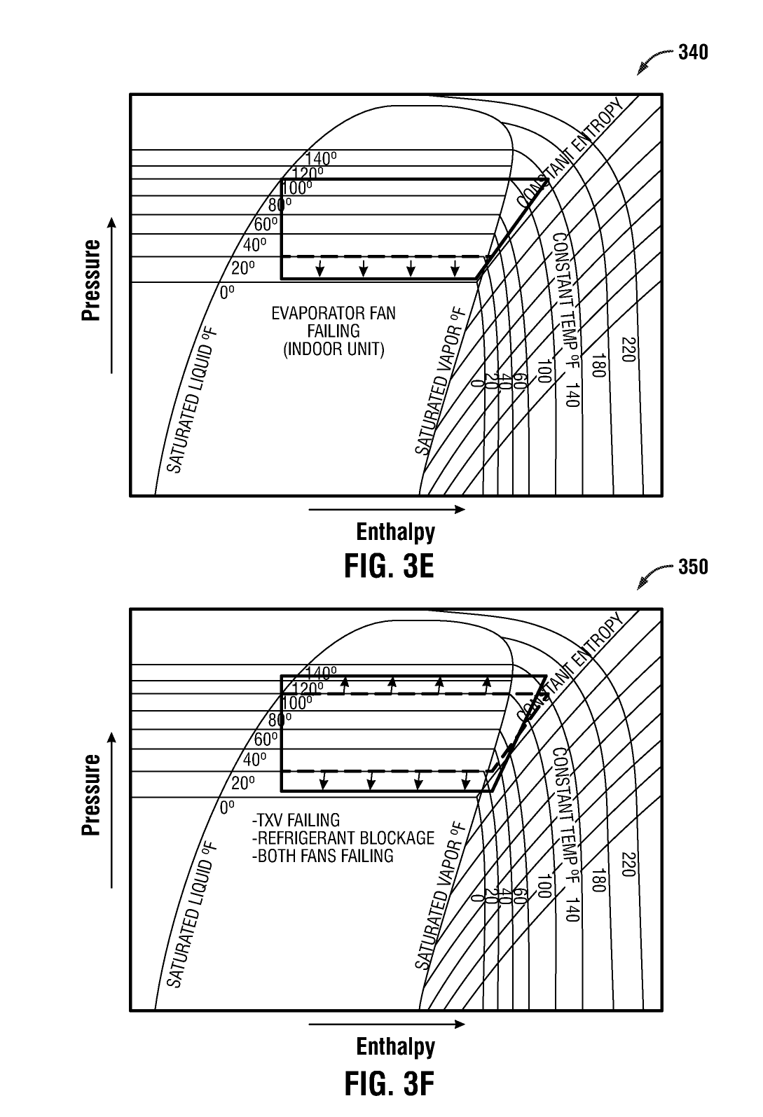

In step 215, the balanced HVAC system has completed initial learning and continues in an operational mode. An exemplary pressure-enthalpy relationship of a balanced HVAC system is illustrated FIG. 3A. Line 301 indicates the temperature and pressure increase (super-heating) imparted by the compressor to the refrigerant gas. Line 302 represents the refrigerant gas enthalpy as it passes through the condenser and condenses to liquid. Line 303 represents the liquid as it passes through the expansion valve, resulting in a simultaneous decrease in temperature and pressure. Line 304 represents the evaporator, from which saturated vapor exits and returns to the compressor, repeating the cycle.

In step 220 (FIG. 2), runtime evaporator enthalpy Hₑ and condenser enthalpy Hₑ are determined and compared to enthalpy targets H_Evap_{target} and H_Cond_{target}, respectively. In step 225, the difference between Hₑ and H_Evap_{target} (ΔHₑ) and/or H_{c} and H_Cond_{target} (ΔH_{c}), is evaluated to determine whether a fault is indicated. In an exemplary embodiment, if the difference between actual and target values of enthalpy is greater than a +/−10% threshold, a fault is indicated. In steps 230-250, the manner in which actual high side and/or low side enthalpy deviates from its corresponding target value is evaluated in detail in steps 230-250 to more precisely determine the nature of the fault.

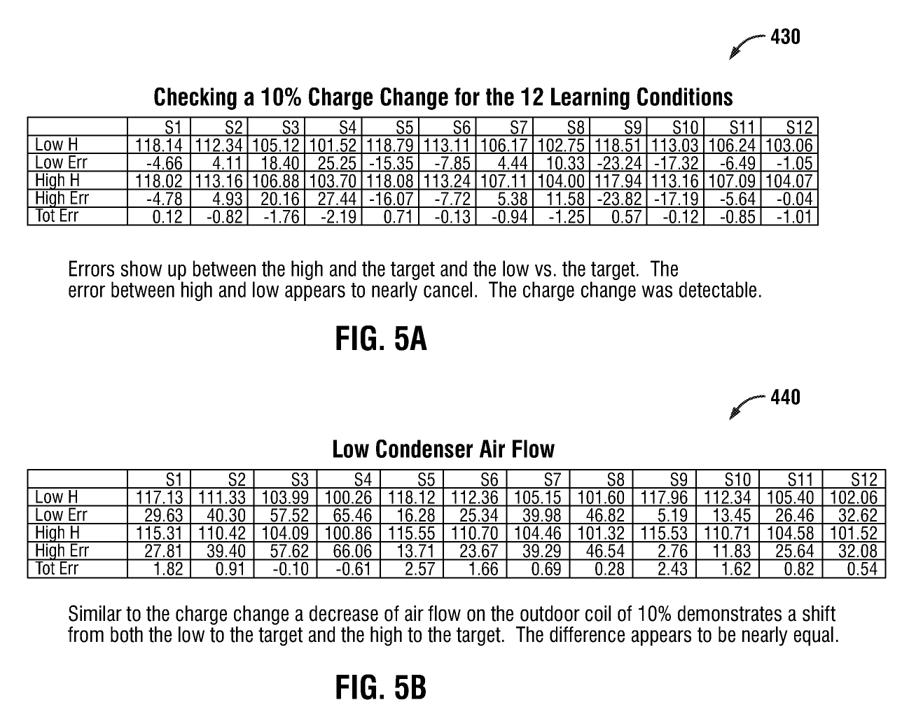

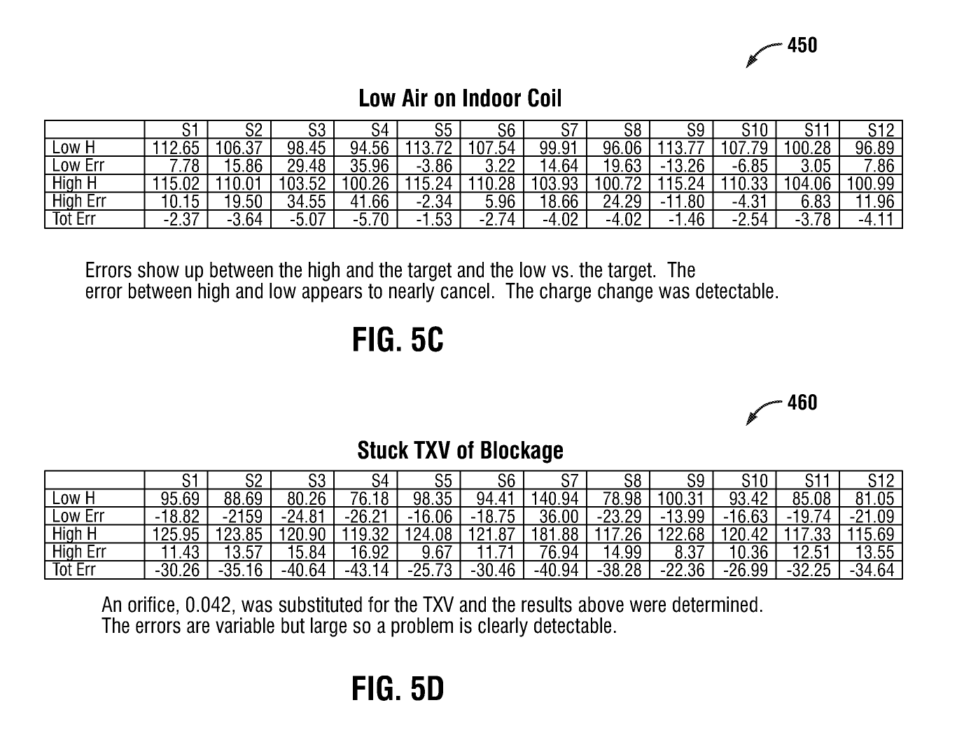

In step 230, if both high side and low side enthalpies are beneath their corresponding thresholds, a refrigerant loss (leak) or insufficient refrigerant charge is indicated. Typically, the pressure-enthalpy relationship resulting from a loss of refrigerant exhibits a downward shift in pressure and an upward shift in enthalpy (FIG. 3B) while conversely, an overcharge condition would manifest as an upward shift in pressure and a downward shift in enthalpy. This relationship is illustrated in FIG. 5A, which depicts a chart 430 showing number of undercharge (S₁, S₅, S₆, S₉, S₁₀, S₁₁, S₁₂) and overcharge (S₂, S₃, S₄, S₇, S₈) conditions.

In step 235, if high side enthalpy is beneath threshold and low side enthalpy is above threshold (FIG. 3C), a compressor failure is indicated.

In step 240, if high side enthalpy is above threshold, but low side enthalpy is within threshold, low condenser airflow is indicated, likely due to a blockage (leaves or other debris in the condenser coil) or a failing outdoor fan motor (FIGS. 3D, 5B).

In step 245, if low side enthalpy is below threshold, but high side enthalpy is within threshold, low evaporator airflow is indicated, likely due to a blockage (clogged air filter) or a failing indoor fan motor (FIGS. 3E, 5C).

In step 250, if high side enthalpy is above threshold and low side enthalpy is below threshold, possible failures include a failing thermal expansion valve, a refrigerant blockage (damaged or clogged tubing), and concurrent condenser and evaporator airflow issues (FIGS. 3F, 5D).

If a fault is indicated in any of steps 230-250, step 255 is performed wherein a fault alert is transmitted. The fault alert may be transmitted to a remote database, a user device (such as a homeowner or HVAC technician's smart phone or tablet), a diagnostic display unit), and/or a thermostat. In embodiments, transmitting a fault alert may include sending a fault message to an HVAC dealer associated with the HVAC system. In embodiments, transmitting a fault alert may include sending an email message, text (SMS) message, and/or an application message (e.g., a push message or notification) to a user device. Note that additional learning is inhibited when a fault has been detected.

In step 260, it is determined that no faults have been identified, e.g., that all enthalpy parameters are within acceptable limits, and therefore, additional learning may be attempted. In step 265, the range of temperatures seen during the initial learning period is compared to the currently-seen temperatures to determine whether any additional temperature ranges remain to be analyzed. For example, if the system is installed during early summer, the outdoor temperature may range from 75° F. to 90° F. during the initial learning period of five days. Four weeks later, in late summer, the temperature may range from 80° F. to 100° F. degrees, which in step 265 enables system parameters for the additional range 90° F. to 100° F. to be sampled. In step 275, the enthalpy targets are re-calculated using data from the expanded temperature range (e.g., the original range plus the newly-sampled range). In subsequent iterations, corresponding to, for example, eight weeks after the initial learning period (e.g., early fall), the temperature may range from 60° F. to 80° F. degrees. At this point, system parameters for the additional 60° F. to 75° F. range will be used to further improve the enthalpy models at the further-expanded temperature range.

In embodiments, historical system parameters are recorded on an ongoing basis for later use. In this manner, the enthalpy models may be dynamically improved as sufficient historical data over a widening range of temperatures becomes available.

### Aspects

It is noted that any of aspects 1-11, any of aspects 12-16, any of aspects 17-18, any of aspects 19-20, and/or aspect 21 may be combined with each other in any combination.

Aspect 1. A method of fault detection in an HVAC system, comprising receiving baseline operating parameters of an HVAC system operating in a known balanced state; computing, from the baseline operating parameters, a set of coefficients for an enthalpy model defining a balanced HVAC system; receiving runtime operating parameters of the HVAC system while the HVAC system is operating in an unknown state; computing an expected enthalpy using the enthalpy model; computing an actual enthalpy using the runtime operating parameters; and transmitting a fault message if the actual enthalpy differs from the expected enthalpy by more than a predetermined amount.

Aspect 2. The method in accordance with aspect 1, wherein the enthalpy model is selected from the group consisting of an evaporator enthalpy model, a condenser enthalpy model, and a compressor enthalpy model.

Aspect 3. The method in accordance with any of aspects 1-2, wherein the evaporator enthalpy model is defined by the formula Hₑ=Mₑ×(TWₑ−TSₑ)+ML×TL+Bₑ.

Aspect 4. The method in accordance with any of aspects 1-3, wherein the condenser enthalpy model is defined by the formula Hₑ=M_{c}×(TS_{c}−TA_{c})+ML_{c}×TL+M_{ew}×TWₑ+B_{c}.

Aspect 5. The method in accordance with any of aspects 1-4, wherein the compressor enthalpy model is defined by the formula H_TS_{c}=H_TSₑ₂₀ (a+b*T_{css}+c*T_{csd}+d*T_{css}²+e*T_{css}*T_{csd} f*T_{csd}²+g*T_{css}³ h*T_{csd}*T_{css}² i*T_{css}*T_{csd}²+j*T_{csd}³)/M_{c}×3.412.

Aspect 6. The method in accordance with any of aspects 1-5, wherein the operating parameters of the HVAC system are selected from the group consisting of compressor input power, compressor efficiency, compressor mass flow, suction saturated temperature, discharge saturated temperature, indoor liquid temperature, indoor dry bulb temperature, indoor wet bulb temperature, outdoor dry bulb temperature, and outdoor wet bulb temperature.

Aspect 7. The method in accordance with any of aspects 1-6, wherein receiving baseline operating parameters includes recording the range of outdoor dry bulb temperatures seen during a first sampling period.

Aspect 8. The method in accordance with any of aspects 1-7, further comprising receiving, during a second sampling period, supplemental operating parameters over a range of outdoor dry bulb temperatures different from those seen during the first sampling period.

Aspect 9. The method in accordance with any of aspects 1-8, further comprising computing, from the baseline operating parameters and the supplemental operating parameters, a set of revised coefficients for the enthalpy model defining a balanced HVAC system.

Aspect 10. The method in accordance with any of aspects 1-9, wherein computing an expected enthalpy includes computing an expected high side enthalpy and an expected low side enthalpy, and wherein computing an actual enthalpy includes computing an actual high side enthalpy and an actual low side enthalpy.

Aspect 11. The method in accordance with any of aspects 1-10, further comprising determining a high side delta indicative of the difference between the expected high side enthalpy and the actual high side enthalpy; determining a low side delta indicative of the difference between the expected low side enthalpy and the actual low side enthalpy; comparing the high side delta and the low side delta to a set of known fault conditions to determine whether a match exists; and formatting the fault message to identify the matched fault in response to a determination that a match exists.

Aspect 12. A post-installation fault detection unit for an HVAC system, comprising a processor; non-transitory memory in operative communication with the processor including a set of executable instructions which, when executed on the processor, cause the processor to compute a set of coefficients for an enthalpy model from a plurality of sensor signals provided by the HVAC system when the HVAC system is operating in a known balanced state; determine an expected enthalpy from the enthalpy model; determine an actual enthalpy from a plurality of sensor signals provided by the HVAC system when the HVAC system is operating in an unknown state; compare the expected enthalpy to the actual enthalpy; and cause to be transmitted a fault message if the actual enthalpy differs from the expected enthalpy by more than a predetermined amount; a diagnostic interface in operative communication with the processor and configured for receiving a plurality of sensor signals; and a communication interface in operative communication with the processor and configured for transmitting the fault message.

Aspect 13. The post-installation fault detection unit in accordance with any of aspect 12, wherein the plurality of sensor signals includes sensor signals selected from the group consisting of compressor input power or current, compressor efficiency, compressor mass flow, suction saturated temperature, discharge saturated temperature, indoor liquid temperature, indoor dry bulb temperature, indoor wet bulb temperature, outdoor dry bulb temperature, and outdoor wet bulb temperature.

Aspect 14. The post-installation fault detection unit in accordance with any of aspects 12-13, wherein the diagnostic interface is configured for receiving a compressor input power sensor signal from a variable speed drive operatively associated with the compressor.

Aspect 15. The post-installation fault detection unit in accordance with any of aspects 12-14, wherein the communication interface is further configured for operative communication with a destination selected from the group consisting of a thermostat, a user device, and a remote database.

Aspect 16. The post-installation fault detection unit in accordance with any of aspects 12-15, wherein the diagnostic interface is further configured to transmit a fault message to a diagnostic display unit.

Aspect 17. An HVAC outdoor unit, comprising a compressor having an inlet and an outlet; a variable-speed drive unit configured to drive an electric motor at variable speed, the electric motor operatively associated with the compressor, the variable-speed drive unit further configured to generate an input power signal indicative of the input power of the electric motor; a suction sensor configured to generate a suction signal indicative of a suction pressure at the compressor inlet; a discharge sensor configured to generate a discharge signal indicative of a discharge pressure at the compressor outlet; a dry bulb temperature sensor configured to generate an outdoor dry bulb temperature signal; a wet bulb temperature sensor configured to generate an outdoor wet bulb temperature signal; and a fault detection unit configured to receive a plurality of sensor signals including at least the input power signal, the suction signal, the discharge signal, the outdoor dry bulb temperature signal, and the outdoor wet bulb temperature signal, the fault detection unit further configured to compute a set of coefficients for an enthalpy model from the plurality of sensor when the HVAC outdoor unit is operating in a known balanced state; determine an expected enthalpy from the enthalpy model; determine an actual enthalpy from the plurality of sensor signals when the HVAC outdoor unit is operating in an unknown state; compare the expected enthalpy to the actual enthalpy; and transmit a fault message if the actual enthalpy differs from the expected enthalpy by more than a predetermined amount.

Aspect 18. The HVAC outdoor unit in accordance with aspect 17, wherein the fault detection unit is further configured to receive, from an HVAC indoor unit, sensor signals including at least a liquid temperature signal, an indoor dry bulb temperature signal, and an indoor wet bulb temperature signal.

Aspect 19. An HVAC indoor unit, comprising an evaporator coil having an inlet a liquid temperature sensor configured to generate a liquid temperature signal indicative of the refrigerant temperature at the evaporator inlet; a dry bulb temperature sensor configured to generate an indoor dry bulb temperature signal; a wet bulb temperature sensor configured to generate an indoor wet bulb temperature signal; and a fault detection unit configured to receive a plurality of sensor signals including at least the liquid temperature signal, the indoor dry bulb temperature signal, and the indoor wet bulb temperature signal, the fault detection unit further configured to compute a set of coefficients for an enthalpy model from the plurality of sensor when the HVAC indoor unit is operating in a known balanced state; determine an expected enthalpy from the enthalpy model; determine an actual enthalpy from the plurality of sensor signals when the HVAC indoor unit is operating in an unknown state; compare the expected enthalpy to the actual enthalpy; and transmit a fault message if the actual enthalpy differs from the expected enthalpy by more than a predetermined amount.

Aspect 20. The HVAC indoor unit in accordance with aspect 19, wherein the fault detection unit is further configured to receive, from an HVAC outdoor unit, sensor signals including at least an input power signal, a suction signal, a discharge signal, an outdoor dry bulb temperature signal, and an outdoor wet bulb temperature signal.

Aspect 21. An HVAC system, comprising an HVAC outdoor unit comprising a compressor having an inlet and an outlet; a variable-speed drive unit configured to drive an electric motor at variable speed, the electric motor operatively associated with the compressor, the variable-speed drive unit further configured to generate an input power signal indicative of the input power of the electric motor; a suction sensor configured to generate a suction signal indicative of a suction pressure at the compressor inlet; a discharge sensor configured to generate a discharge signal indicative of a discharge pressure at the compressor outlet; a dry bulb temperature sensor configured to generate an outdoor dry bulb temperature signal; a wet bulb temperature sensor configured to generate an outdoor wet bulb temperature signal; an HVAC indoor unit, comprising an evaporator coil having an inlet; a liquid temperature sensor configured to generate a liquid temperature signal indicative of the refrigerant temperature at the evaporator inlet; a dry bulb temperature sensor configured to generate an indoor dry bulb temperature signal; a wet bulb temperature sensor configured to generate an indoor wet bulb temperature signal; and a fault detection unit configured to receive a plurality of sensor signals including at least the input power signal, the suction signal, the discharge signal, the outdoor dry bulb temperature signal, the outdoor wet bulb temperature signal, the liquid temperature signal, the indoor dry bulb temperature signal, and the indoor wet bulb temperature signal, the fault detection unit further configured to compute a set of coefficients for an enthalpy model from the plurality of sensor when the HVAC outdoor unit is operating in a known balanced state; determine an expected enthalpy from the enthalpy model; determine an actual enthalpy from the plurality of sensor signals when the HVAC outdoor unit is operating in an unknown state; compare the expected enthalpy to the actual enthalpy; and transmit a fault message if the actual enthalpy differs from the expected enthalpy by more than a predetermined amount.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in any appropriately detailed structure.

What is claimed is:

1. A method of fault detection in an HVAC system, comprising:
receiving baseline operating parameters of an HVAC system operating in a known balanced state;
computing, from the baseline operating parameters, a set of coefficients for an enthalpy model defining a balanced HVAC system;
receiving runtime operating parameters of the HVAC system while the HVAC system is operating in an unknown state;
computing an expected enthalpy using the enthalpy model;
computing an actual enthalpy using the runtime operating parameters; and
transmitting a fault message if the actual enthalpy differs from the expected enthalpy by more than a predetermined amount.

2. The method in accordance with claim 1, wherein the enthalpy model is selected from the group consisting of an evaporator enthalpy model, a condenser enthalpy model, and a compressor enthalpy model.

3. The method in accordance with claim 2, wherein the evaporator enthalpy model is defined by the formula Hₑ=Mₑ×(TWₑ−TSₑ)+ML×TL+Bₑ.

4. The method in accordance with claim 2, wherein the condenser enthalpy model is defined by the formula Hₑ=M_{c}×(TS_{c}−TA_{c})+ML_{c}×TL+M_{ew}×TWₑ+Bₑ.

5. The method in accordance with claim 2, wherein the compressor enthalpy model is defined by the formula H_TS_{c}=H_TSₑ₂₀++b*T_{css}+c*T_{csd} d*T_{css}² e*T_{css}*T_{csd}+f*T_{csd}²+g*T_{css}³+h*T_{csd}*T_{css}² i*T_{css}*T_{csd}+j*T_{csd}³)/M_{c}×3.412.

6. The method in accordance with claim 1, wherein the operating parameters of the HVAC system are selected from the group consisting of compressor input power, compressor efficiency, compressor mass flow, suction saturated temperature, discharge saturated temperature, indoor liquid temperature, indoor dry bulb temperature, indoor wet bulb temperature, outdoor dry bulb temperature, and outdoor wet bulb temperature.

7. The method in accordance with claim 1, wherein receiving baseline operating parameters includes recording the range of outdoor dry bulb temperatures seen during a first sampling period.

8. The method in accordance with claim 7, further comprising receiving, during a second sampling period, supplemental operating parameters over a range of outdoor dry bulb temperatures different from those seen during the first sampling period.

9. The method in accordance with claim 8, further comprising computing, from the baseline operating parameters and the supplemental operating parameters, a set of revised coefficients for the enthalpy model defining a balanced HVAC system.

10. The method in accordance with claim 1, wherein computing an expected enthalpy includes computing an expected high side enthalpy and an expected low side enthalpy, and wherein computing an actual enthalpy includes computing an actual high side enthalpy and an actual low side enthalpy.

11. The method in accordance with claim 10, further comprising:
determining a high side delta indicative of the difference between the expected high side enthalpy and the actual high side enthalpy;
determining a low side delta indicative of the difference between the expected low side enthalpy and the actual low side enthalpy;
comparing the high side delta and the low side delta to a set of known fault conditions to determine whether a match exists; and
formatting the fault message to identify the matched fault in response to a determination that a match exists.

12. A post-installation fault detection unit for an HVAC system, comprising:
a processor,
non-transitory memory in operative communication with the processor including a set of executable instructions which, when executed on the processor, cause the processor to:
compute a set of coefficients for an enthalpy model from a plurality of sensor signals provided by the HVAC system when the HVAC system is operating in a known balanced state;
determine an expected enthalpy from the enthalpy model;
determine an actual enthalpy from a plurality of sensor signals provided by the HVAC system when the HVAC system is operating in an unknown state;
compare the expected enthalpy to the actual enthalpy; and
cause to be transmitted a fault message if the actual enthalpy differs from the expected enthalpy by more than a predetermined amount;
a diagnostic interface in operative communication with the processor and configured for receiving a plurality of sensor signals; and
a communication interface in operative communication with the processor and configured for transmitting the fault message.

13. The post-installation fault detection unit in accordance with claim 12, wherein the plurality of sensor signals includes sensor signals selected from the group consisting of compressor input power, compressor efficiency, compressor mass flow, suction saturated temperature, discharge saturated temperature, indoor liquid temperature, indoor dry bulb temperature, indoor wet bulb temperature, outdoor dry bulb temperature, and outdoor wet bulb temperature.

14. The post-installation fault detection unit in accordance with claim 12, wherein the diagnostic interface is configured for receiving a compressor input power sensor signal from a variable speed drive operatively associated with the compressor.

15. The post-installation fault detection unit in accordance with claim 12, wherein the communication interface is further configured for operative communication with a destination selected from the group consisting of a thermostat, a user device, and a remote database.

16. The post-installation fault detection unit in accordance with claim 12, wherein the diagnostic interface is further configured to transmit a fault message to a diagnostic display unit.

17. An HVAC outdoor unit, comprising:
a compressor having an inlet and an outlet;
a variable-speed drive unit configured to drive an electric motor at variable speed, the electric motor operatively associated with the compressor, the variable-speed drive unit further configured to generate an input power signal indicative of the input power of the electric motor;
a suction sensor configured to generate a suction signal indicative of a suction pressure at the compressor inlet;
a discharge sensor configured to generate a discharge signal indicative of a discharge pressure at the compressor outlet;
a dry bulb temperature sensor configured to generate an outdoor dry bulb temperature signal;
a wet bulb temperature sensor configured to generate an outdoor wet bulb temperature signal; and
a fault detection unit configured to receive a plurality of sensor signals including at least the input power signal, the suction signal, the discharge signal, the outdoor dry bulb temperature signal, and the outdoor wet bulb temperature signal, the fault detection unit further configured to:
compute a set of coefficients for an enthalpy model from the plurality of sensor when the HVAC outdoor unit is operating in a known balanced state;
determine an expected enthalpy from the enthalpy model;
determine an actual enthalpy from the plurality of sensor signals when the HVAC outdoor unit is operating in an unknown state;
compare the expected enthalpy to the actual enthalpy; and
transmit a fault message if the actual enthalpy differs from the expected enthalpy by more than a predetermined amount.

18. The HVAC outdoor unit in accordance with claim 17, wherein the fault detection unit is further configured to receive, from an HVAC indoor unit, sensor signals including at least a liquid temperature signal, an indoor dry bulb temperature signal, and an indoor wet bulb temperature signal.

19. An HVAC indoor unit, comprising:
an evaporator coil having an inlet;
a liquid temperature sensor configured to generate a liquid temperature signal indicative of the refrigerant temperature at the evaporator inlet;
a dry bulb temperature sensor configured to generate an indoor dry bulb temperature signal;
a wet bulb temperature sensor configured to generate an indoor wet bulb temperature signal; and
a fault detection unit configured to receive a plurality of sensor signals including at least the liquid temperature signal, the indoor dry bulb temperature signal, and the indoor wet bulb temperature signal, the fault detection unit further configured to:
compute a set of coefficients for an enthalpy model from the plurality of sensor when the HVAC indoor unit is operating in a known balanced state;
determine an expected enthalpy from the enthalpy model;
determine an actual enthalpy from the plurality of sensor signals when the HVAC indoor unit is operating in an unknown state;
compare the expected enthalpy to the actual enthalpy; and
transmit a fault message if the actual enthalpy differs from the expected enthalpy by more than a predetermined amount.

20. The HVAC indoor unit in accordance with claim 19, wherein the fault detection unit is further configured to receive, from an HVAC outdoor unit, sensor signals including at least an input power signal, a suction signal, a discharge signal, an outdoor dry bulb temperature signal, and an outdoor wet bulb temperature signal.
